(19) United States
(12) Patent Application Publication
(10) Pub. No.: US 2008/0044097 A1
(43) Pub. Date: Feb. 21, 2008

(54) Fast JPEG-LS Based Compression Method for Medical Images

(75) Inventors: Smita Krishnan, Yardley, PA (US); Qiang Cheng, Carbondale, IL (US); Min Xie, Plainsboro, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 11/779,459

(22) Filed: Jul. 18, 2007

Related U.S. Application Data
(60) Provisional application No. 60/839,068, filed on Aug. 21, 2006.

(51) Int. Cl. G06K 9/38

(52) U.S. Cl. 382/251

(57) ABSTRACT

A system and method provide image data compression and reconstruction technique optimizations that may enhance (1) local gradient quantization, (2) quantized gradient merging, and/or (3) prediction and/or prediction error computations. A data structure may be created before image data compression that provides access to pre-computed quantization values during image data compression. Quantization merging may be performed by a one-to-one mapping of quantization vectors into corresponding quantization values. Subsequently, the sign of the quantization values may be checked to further reduce the number of logical steps required. A prediction technique may alleviate the effect that noise of neighboring pixels has on the current pixel. The optimizations may be applied to a JPEG-LS based algorithm to speed up processing by approximately 50%, while maintaining error controllability and compression ratio. The optimizations may enhance remote rendering and viewing of medical images in a client server environment.

### PRIORITY AND CROSS-REFERENCE TO RELATED APPLICATION

This application claims priority under 35 U.S.C. §119(e) to provisional application Ser. No. 60/839,068, filed on Aug. 21, 2006 and entitled “Fast JPEG-LS Base Compression Method for Medical Images,” which is incorporated by reference herein in its entirety.

### FIELD OF THE INVENTION

The present embodiments relate generally to image compression techniques. In particular, the present embodiments relate to image compression technique optimizations.

### BACKGROUND

The conventional JPEG-LS algorithm is one of the compression standards developed by the Joint Photographic Experts Group. JPEG-LS was developed to provide a “near lossless” image compression standard that could offer better compression efficiency than the pre-existing lossless JPEG methodology. The foundation of JPEG-LS is based upon the LOCO-I algorithm, which itself relies upon residual modeling and context-based coding of the residuals. Conventional JPEG-LS techniques may rely upon an assumption that the prediction residuals follow a two-sided geometric or Laplace distribution. JPEG-LS techniques also may use Golomb-like codes, which may be useful for geometric distributions.

However, due to the computational complexity of typical JPEG-LS based algorithms used in conjunction with some types of image data, the speed of compression may be limited. As a result, standard JPEG-LS compression speeds and resulting average frame rates may be too slow to be of practical use in certain situations. For example, known JPEG-LS techniques may have limitations when used in clinical environments.

### BRIEF SUMMARY

By way of introduction, the embodiments described below include methods, processes, apparatuses, instructions, or systems for enhancing image data compression and reconstruction techniques. The most expensive operations, in terms of time and/or processing requirements, associated with a JPEG-LS based compression method, may be identified and subsequently optimized. The present compression and reconstruction techniques may provide for enhanced (1) local gradient quantization, (2) quantized gradient merging, and/or (3) prediction and/or prediction error computations. The optimizations identified herein may be performed on JPEG-LS based or other compression techniques. In one embodiment, the optimizations are applied to a clinical environment that requires the compression, transfer, and reconstruction of medical image data.

In a first aspect, a method provides for image data compression. The method includes creating a data structure, before commencing compression of image data, associated with quantization values for the image data to be compressed, each quantization value based upon a corresponding local gradient. The method also includes subsequently retrieving the quantization values via the data structure to facilitate compression of the image data, merging quantized gradients by performing a one-to-one mapping of a quantization vector into an integer, and computing a prediction value using an equation that accepts as input information related to more than one neighboring pixel of the current pixel.

In a second aspect, a method provides for image data compression. The method includes creating a data structure before or at the start of image data compression, the data structure pertaining to quantization values associated with image data to be compressed, each quantization value based upon a corresponding local gradient. The method also includes subsequently retrieving the quantization values via the data structure during compression of the image data.

In a third aspect, a method provides for image data compression. The method includes determining pre-computed quantization values associated with image data to be compressed prior to compressing the image data. The method also includes subsequently using the pre-computed quantization values to facilitate compression of the image data.

In a fourth aspect, a method provides for image data compression. The method includes, during image data compression, performing a one-to-one mapping of a quantization vector into an integer quantization value, and subsequently performing quantization merging.

In a fifth aspect, a data processing system provides for image data compression. The system includes a processor operable to compress image data, wherein the processor employs a prediction method that accounts for noise of neighbor pixels of a current pixel, the prediction method computes a final prediction value using a single equation that operates on information associated with more than one neighbor pixel of the current pixel.

In a sixth aspect, a computer-readable medium having instructions executable on a computer is described. The instructions include creating a data structure associated with image data to be compressed, the data structure being operable to provide for subsequent retrieval of pre-computed quantization values during compression of the image data.

Embodiments of the present invention are defined by the claims set forth herein. Nothing in this section should be taken as a limitation on those claims. Further aspects and advantages of the invention are discussed below in conjunction with the exemplary embodiments and may be later claimed independently or in combination.

### DESCRIPTION OF THE DRAWINGS

The present exemplary embodiments will become more fully understood from the detailed description given herein below and the accompanying drawings, which are given by way of illustration only, and are not limitative of the present invention, and wherein:

FIG. 1 illustrates an exemplary method of image compression and reconstruction;

FIG. 2 illustrates an exemplary Fast JPEG-LS method;

FIG. 3 illustrates an exemplary context window;

FIG. 4 illustrates an exemplary look-up table of quantization values; and

FIG. 5 illustrates an exemplary data processing system operable to implement the fast JPEG-LS method.

### DETAILED DESCRIPTION OF EXEMPLARY EMBODIMENTS

The embodiments described herein include methods, processes, apparatuses, instructions, or systems for enhanced image data compression and reconstruction. Optimizations may be made to known or other image compression techniques. The optimizations may enhance (1) local gradient quantization, (2) quantized gradient merging, and/or (3) prediction and/or prediction error computations. In one embodiment, the optimizations identified herein may be applied to a JPEG-LS based compression technique.

The known JPEG-LS algorithm was designed mainly for lossless and near lossless compression applications. JPEG-LS may be suited for applications in which the maximum error introduced by compression may be controlled by the user. In addition, JPEG-LS may provide a better average lossless compression ratio than other commonly used compression methods. However, one of the obstacles in using JPEG-LS within a client server environment is its relatively high computational complexity. For example, compared with the commonly used JPEG algorithm, JPEG-LS compression may be more than two times slower.

In general, the present embodiments provide a new light weight compression method, referred to herein as “Fast JPEG-LS” or “FJPLS,” that may be based upon the JPEG-LS algorithm. The present embodiments related to the Fast JPEG-LS techniques may have the same advantages as the original JPEG-LS method associated with error controllability and compression ratio. At the same time, the Fast JPEG-LS embodiments may speed up the compression and decompression of JPEG-LS based methods by about 50%

In one embodiment, the Fast JPEG-LS optimizations are applied to a clinical environment that requires the compression, transfer, and reconstruction of medical image data. JPEG-LS is an established compression method for continuous toned images. As noted above, one of the main advantages of using JPEG-LS as compared with other compression standards is the controllability of the maximum compression error. This feature may be essential for medical applications where any kind of uncontrolled error could potentially cause an erroneous or incomplete diagnosis. Compared with other compression methods, JPEG-LS also may provide better lossless compression ratios. These advantages may make JPEG-LS a potential option for certain medical imaging applications.

Still, due to the computational complexity of the conventional JPEG-LS algorithm, the speed of compression may be limited. For instance, the compression speed of a 512×512 12-bit computed tomography (CT) image is about 30 ms on a 3.2 GHz Pentium-IV workstation. In a regular clinical use case, 4 window segments of size 512×512 may need to be updated remotely. The average fame rate may, therefore, be less than 8 frames per second using the conventional JPEG-LS algorithm. A frame rate of this magnitude may not satisfy the typical clinical use situation that may require the remote rendering and viewing of medical images in a client server environment.

JEG-LS is a one pass algorithm that primarily works in to modes of operation: (1) Run or Run-length Mode ad (2) Regular Mode. The Run-length encoding Mode encodes image regions that are uniform, or “flat⇄—where the pixel values are identical or nearly identical (less than a defined maximum error). However, in continuous toned images, such as medical images, uniform or flat regions may be relatively scarcely found, other than perhaps within the background portions of the images. Hence, generally during compression, the compressor may spend most of the time in the Regular Mode of operation.

Table 1 below shows an exemplary performance profile of a JPEG-LS algorithm where the Regular Mode occupies 57% of total computational load, while the Run Mode occupies only a small fraction, about 7% of the total computational load. The remaining computational loads are shown as being within the “Other Modes” category in Table 1. The Other Modes may include data fetching, data coding, and other processing operations.

TABLE 1
JPEG-LS MODES OF OPERATION

| | Clocktick | |
|---|---|---|
| Modes | Samples | Clockticks % |
| Regular Mode | 124 | 57.41% |
| Run Mode | 16 | 7.41% |
| Other Modes | 76 | 35.19% |

Therefore, in order to best increase the speed of the JPEG-LS compression algorithm, improving the operational performance when the processor is operating in Regular Mode may be advantageous. As noted, with the present embodiments, a new light weight compression method based upon the JPEG-LS algorithm is provided. The modified version of the algorithm, FJPLS, may have the same advantages as the original JPEG-LS method associated with error controllability and compression ratio. At the same time, the new FJPLS method may speed up the compression and decompression by nearly 50%. In the above clinical use example, the average frame rate of each window segment is increased from 8 frames per second to 16 frames per second using the FJPLS optimizations identified herein. The FJPLS method may employ one or more of the optimizations discussed below. For instance, the FJPLS method may employ a single optimization, a combination of optimizations, or all of the optimizations concurrently.

Table 2 highlights the performance profile of Regular Mode operations. According to the comparison below, the most expensive operations of JPEG-LS identified relate to (1) local gradient quantization, (2) quantized gradient merging, and (3) prediction/prediction error computation. The FJPLS embodiments may focus upon improving the performance of these computationally expensive portions of the JPEG-LS algorithm, although other portions also may be enhanced, such as updating regular variables. The FJPLS optimizations may modify the JPEG LS algorithm so as to yield the best performance in terms of speed and processing requirements without sacrificing either the controllability of maximum error or substantial compression ratio.

TABLE 2
JPEG-LS REGULAR MODE FUNCTIONS

| | | Clocktick | |
|---|---|---|---|
| Rank | Functions | Samples | Clockticks % |
| 1 | Quantize Local | 45 | 36.29% |
| | Gradients | | |
| 2 | Quantization Merging | 17 | 13.71% |
| 3 | Prediction Calculation | 17 | 13.71% |
| 4 | Update Regular | 15 | 12.10% |
| | Variables | | |
| 5 | Prediction Error - | 12 | 9.68% |
| | Calculation, | | |
| | Modulation and | | |
| | Mapping | | |
| 6 | Others | 18 | 14.52% |

### I. Exemplary Compression and Reconstruction

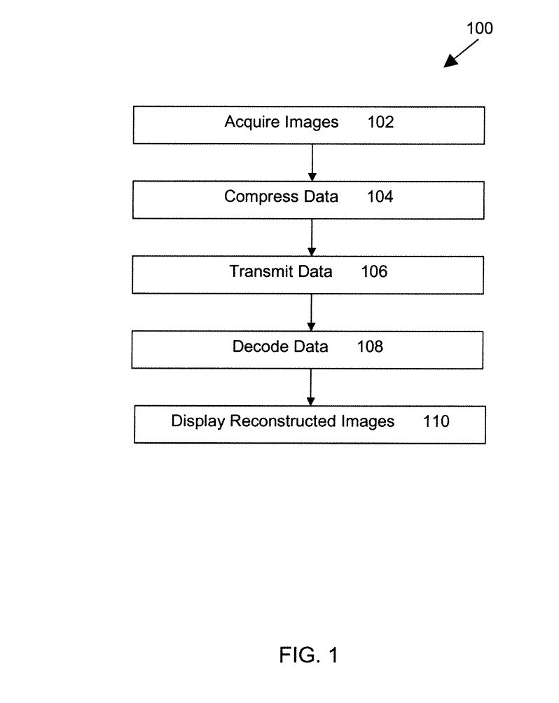

FIG. 1 illustrates an exemplary method of image data compression, transfer, and reconstruction. The method 100 may include acquiring images 102, compressing the image data 104, transmitting the compressed data 106, decoding the compressed data 108, and displaying the reconstructed images 110. The method may include additional, fewer, or alternate actions.

The method 100 may include acquiring images 102. The images acquired may have associated image data. The image data may be stored within a storage medium, as discussed below. The images and associated image data may be acquired via medical imaging devices, cameras, video recorders, sensors, detectors, infrared devices, or other imaging devices. The image data may be related to either medical images or non-medical images, such as ordinary pictures of people or objects.

As noted, in one embodiment, the image data may be associated with medical images acquired via one or more medical imaging devices. Various types of medical imaging processes may be used to produce patient images, scans of internal regions of interest, or other image data, including radiography, angioplasty, computerized tomography, ultrasound and magnetic resonance imaging (MRI) processes. Additional types of imaging processes that may be used include perfusion and diffusion weighted MRI, cardiac computed tomography, computerized axial tomographic scan, electron-beam computed tomography, radionuclide imaging, radionuclide angiography, single photon emission computed tomography (SPECT), cardiac positron emission tomography (PET), digital cardiac angiography, and digital subtraction angiography (DSA). Alternate imaging processes may be used.

The method 100 may include compressing the image data 104. The image data may be compressed to enhance transmission speed and/or conform to a bandwidth limit of a wired network, a wireless network, cabling, or other transmission by which the compressed image data is to be transmitted. The image data being compressed may be directly received from an imaging device, such as to facilitate remote capture and local viewing of images in real-time. Alternatively, the image data being compressed may be first stored in and then retrieved from a data storage unit, such as for applications in which real-time viewing is not necessary.

For instance, it may be desirable to almost instantaneously view image data of a patient acquired via a medical imaging device at an area remote from a radiation emitting imaging device. Or, at a local medical facility, it may be desirable to view previously acquired medical images of a patient that were taken at a remote medical facility.

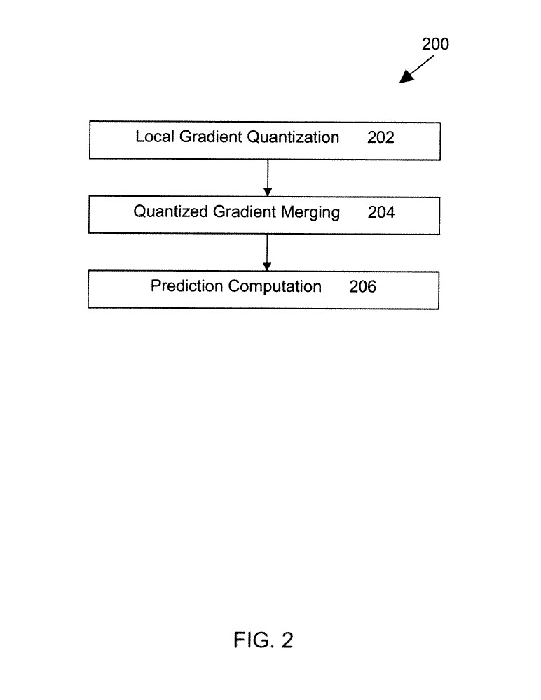

The image data may be compressed by a Fast JPEG-LS technique that employs the optimizations discussed with respect to FIG. 2 below. The image compression technique may employ context-based threshold values. The threshold values may be viewed as being a function of the “context” of an image pixel being encoded. The image data may be quantized pixel by pixel. Each pixel may be associated with a quantized gradient and then slotted to fall within a specific quantization region. The quantization regions may be defined by the thresholds, which themselves may be associated with a gray level of the pixel and have an integer value, such as 50, 100, 150, etc. In one aspect, the threshold level may be between −255 to 255 (or from 0 to 510 normalized), depending on the level of pixel grayness.

Other threshold values may be used. For instance, U.S. Pat. No. 6,021,227, which is incorporated herein by reference in its entirety, illustrates exemplary threshold values that may be used.

The method may include transmitting the compressed image data 106. The compressed stream of image data may be transmitted over wired or directly interconnected components, such as a local processor associated with a medical imaging device interconnected with a medical work station. The work station may direct one or more display screens on which the decompressed image data is displayed. Alternatively, the compressed stream of image data may be transmitted over a wireless network.

The compressed stream of data may include pixel data, control data, and other data. For instance, the compressed data being transmitted may include scaling factors and/or various mathematical matrixes used to reconstruct and/or decode the encoded images after the image data is received by a remote computer. U.S. Pat. No. 6,754,383, incorporated herein by reference in its entirety, illustrates an example of transmitting non-pixel data within a compressed data stream.

Compressing/encoding the image data may reduce the amount of data required to represent the quantized image data. For example, the original image to be compressed may be divided into a frame, a page, or a block of pixels, such as a block of 8×8 pixels. The reduced amount of encoded image data may facilitate faster transfer rates. The number of bits used to represent quantized approximation values may be reduced via Huffman encoding, digital cosine transform (DCT), algorithmic, or other techniques.

The method 100 may include decoding or decompressing the compressed image data 108. Decompression of the image data may be performed by reversing the compression process to reproduce the images encoded. Exemplary methods performing decompression by reversing the compression process are illustrated by U.S. Pat. Nos. 5,495,538, 6,259,820, and 7,177,479, which are all incorporated herein by reference in their entireties.

The method 100 may include displaying the reconstructed images 110 on one or more displays. The displays may be associated with either a local or a remote processor. The images may be displayed via an interactive user interface that permits the user to perform various operations on the images being displayed, such as identifying regions of interests. Other operations may be performed on the image data, including operations detailed elsewhere herein.

### II. Exemplary Fast JPEG-LS Technique

FIG. 2 illustrates an exemplary Fast JPEG-LS based compression method. The Fast JPEG-LS compression method 200 may optimize and/or improve the processing speed of a typical JPEG-LS based technique. The Fast JPEG-LS method 200 may include optimizations related to local gradient quantization 202, quantized gradient merging 204, and/or prediction and/or prediction error computations 206. The Fast JPEG-LS method may include additional, fewer, or alternative optimizations.

A. Local Gradient Quantization Optimization

The Fast JPEG-LS based compression method 200 may include an optimization related to local gradient quantization 202. However, to begin, an explanation of JPEG-LS is in order.

With JPEG-LS, the first step towards compressing each pixel may be to determine its context. In the context determination model, each current pixel (Ix) may be conditioned according to its neighboring four pixels (Ra, Rb, Rc, and Rd).

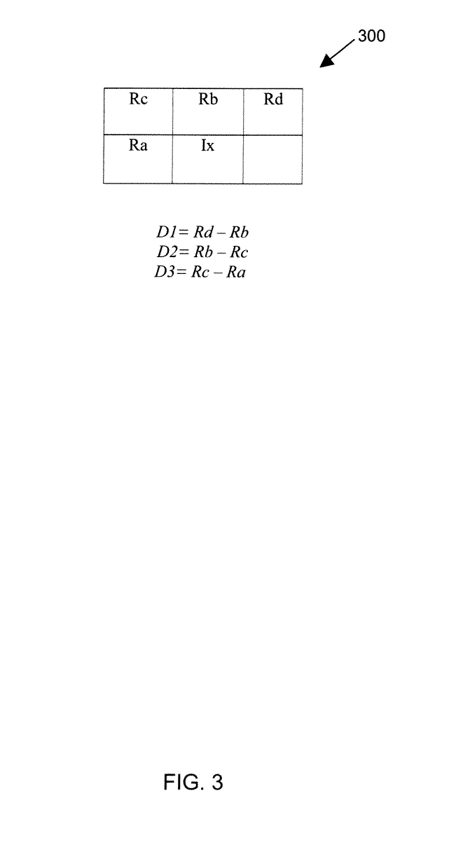

As illustrated by FIG. 3, three local gradient values (D1, D2, and D3) may be calculated for the current pixel, Ix. As shown, the local gradient may be identified as D1, D2, and D3. D1 may be defined as Rd-Rd. D2 may be defined as Rb-Rc. D3 may be defined as Rc-Ra. For reduction of the model size, each of these exemplary local gradients (Di) of FIG. 3 may be quantized into a corresponding quantization value Qi depending on their relationship between the non-negative thresholds T1, T2 and T3 as shown in Table 3 below.

TABLE 3
Local Gradient Quantization

| | | |
|---|---|---|
| Qi = | −4 | if Di ≦ −T3 |
| | −3 | if −T3 < Di ≦ −T2 |
| | −2 | if −T2 < Di ≦ −T1 |
| | −1 | if −T1 < Di < 0 |
| | 0 | if Di = 0 |
| | 1 | if 0 < Di < T1 |
| | 2 | if T1 < Di < T2 |
| | 3 | if T1 < Di < T3 |
| | 4 | otherwise |

However, in order to quantize each of the local gradients, D1, D2 and D3, for every Regular Mode pixel, the above JPEG-LS methodology may use a number of logical steps which are computationally very expensive.

The Fast JPEG-LS embodiments may account for local gradients and neighboring pixels in a different manner than a typical JPEG-LS technique. Before or at the initial stages of image data compression, Fast JPEG-LS may create a data structure that provides for subsequent access to pre-computed quantization values during image data compression. Accessing pre-computed quantization values via a data structure during image data compression may be computationally simpler/more efficient than computing a quantization value for each local gradient and/or pixel in real-time during image data compression. With Fast JPEG-LS, a single data structure may be created once for an image, or subset thereof, to be compressed.

The creation of the data structure may involve analyzing the gray levels of and between individual pixels, such as to determine local gradients. Based upon the gray level of a pixel or a corresponding local gradient, that pixel may be characterized as belonging to one of a number of quantization regions. The quantization regions may be defined by thresholds, such as the threshold values discussed above. As a result of creating the data structure, during image data compression, the Fast JPEG-LS logic need only look to the data structure to determine a quantization value for a corresponding pixel. As a result, a number of logical steps associated with typical JPEG-LS techniques may be eliminated.

Additionally, the use of the data structure associated with quantization values may permit a greater number of quantization regions to be used without increasing the complexity of the Fast JPEG-LS logic. For example, the data structure may be a static structure that provides access to quantization values that are based upon corresponding quantization regions and/or pixels. Pre-computing the quantization values itself may become more complex as the number of quantization regions increases.

However, by pre-computing the quantization values, during subsequent image data compression, all that may be required to determine a quantization value is to access the data structure and retrieve the pre-computed quantization value. The complexity of accessing the data structure will not change based upon how the pre-computed quantization value was actually computed. In one aspect, the Fast JPEG-LS method may employ more than 9 quantization regions without increasing the complexity of the image data compression. Increasing the number of quantization regions employed may enhance the quality of images displayed after data decompression.

The data structure may be a dynamic or static data structure. The data structure may be a list, tree, binary tree, queue, stack, table, m-way tree, linked list, heap, parse tree, hash table, or other data structure. The data structure may have one or more dimensions. 00501 In one embodiment, the Fast JPEG-LS method may employ a look-up table as the data structure. The Fast JPEG-LS method may use the look-up table to find a corresponding quantization value Q for each pixel when that pixel is being compressed. Unlike a conventional JPEG-LS technique, the Fast JPEG-LS look-up table may provide for as many quantization regions or groups as desired. Additionally, the look-up table may alleviate the need to compute quantization values for each pixel when the pixels are being compressed.

For instance, in order to optimize the quantization process, the Fast JPEG-LS algorithm may create a look-up table (Quantization Table or “QTable”) at the start of the compression. The look-up table may be created only once per image compression. The look-up table may be generated in real-time or at run-time. Alternatively, the look-up table may be stored in full or in part in either a local or a remote memory. In one embodiment, the look-up table is of size 512 bytes. Look-up tables of larger or smaller size may be used.

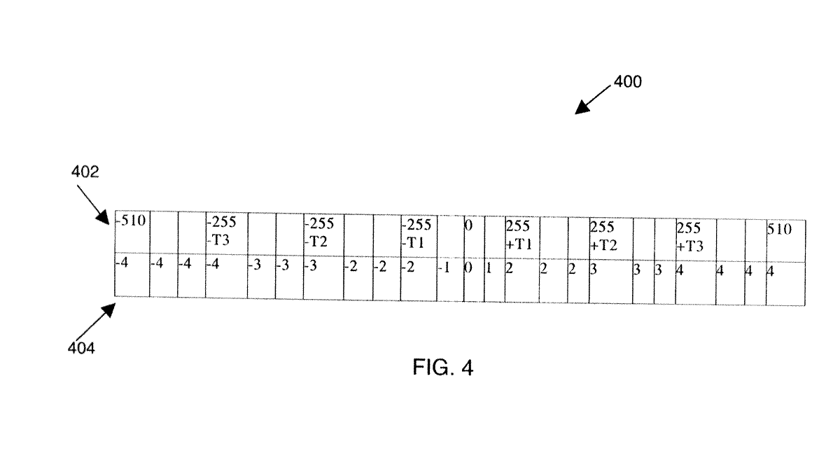

FIG. 4 illustrates an exemplary QTable or look-up table 400. The exemplary look-up table 400 has two rows 402, 404. The first row 402 may indicate the indices of the look-up table 400. The indices may correspond to the gray level of the current pixel, from −255 to +255. Other indices may be used.

The second row 404 may represent various quantization regions or levels, each of which may be associated with a quantization value. As shown in FIG. 4, the exemplary look-up table employs 9 quantized regions identified by the quantized values −4 to +4. The quantized value associated with the indices may be determined in relation to the threshold values used. The use of the look-up table 400 to obtain quantized values, instead of individually computing each quantized value during image data compression, may enhance the efficiency of the overall technique and save computing resources, such as memory and/or processing capabilities, and reduce processing time.

The look-up table 400 may have values that are either hardware or software encoded. Alternative look-up tables may be used. The look-up table may have additional, fewer, or alternate rows of data.

The exemplary look-up table shown in FIG. 4 is divided into 9 regions which may represent the quantization regions formed by the thresholds T1, T2 and T3. Each of these regions may be filled with a quantization value Qi (−4 to +4), which may be a positive or negative integer.

During the Regular Mode of operation, a constant “offset” (2ⁿ−1, with n being the number of bits per pixel within an image, such as 8 bits per pixel) is added to the local gradients for conversion to unsigned values. Additionally, with Fast JPEG-LS, the local gradient Di may be determined as above for an individual pixel. Then, for every pixel, the value of the local gradient Di may be used to look up, find, or otherwise access the corresponding quantization value Qi in the look-up table.

One manner of accessing the quantization values of the look-up table is illustrated by the equation below, which uses the local gradient associated with a pixel plus an offset as an index. The index is used to retrieve the quantization value corresponding to the pixel from the data structure, in this case a look-up table. Other indexes may be used. For instance, the index may be a value based upon the local gradient value, such as the local gradient itself or the sum of the local gradient and the offset calculated.

Qi=QTable[Di+offset]

In one aspect, with images containing greater than 8 bits/pixel, one option may be to use a larger QTable to incorporate a wider range of pixel values. However, using a larger QTable or other data structure may result in an increase in memory consumption.

Alternatively, a better option may be to normalize the threshold values, T1 T2, and T3, in the range of 0 to 255 and then construct the QTable or other data structure accordingly. This reduction in the precision of the threshold values may not cause any significant changes in terms of compression ratios.

Next, for each local gradient value Di, the local gradient value Di may be normalized within the range of −255 to 255. Subsequently, as before, a constant “offset” may be added to the normalized local gradient value Di before looking up the quantization value Qi from the QTable.

Qi=QTable[normalized Di+offset

The QTable may be implemented as a static or dynamic array. The size of the QTable may be computed in runtime. The QTable may alternatively be a tree, binary tree, list, queue, stack, table, m-way tee, linked list, heap, parse tree, hash table, or other data structure. The QTable may have one or more dimensions.

Increasing the number of quantization regions, in theory, maximizes the mutual information between the current pixel and the context. The JPEG-LS standard may use three thresholds (or 9 regions identified as −4, −3, −2, −1, 0, 1, 2, 3, and 4) to provide a good balance between low computation and designing the context model. With the present Fast JPEG-LS method, the number of quantized regions may be increased from 9 to N number of regions without a significant increase in the computational complexity. The increase in the number of regions may enhance the accuracy and quality of images being reconstructed. The enhanced quality of reconstructed images may in turn facilitate more accurate and/or more efficient diagnosis if the image data being transferred is medical image data.

Additionally, the Fast JPEG-LS embodiments may use alternate local gradients and/or context windows as those described above. For instance, instead of the context window including Ra, Rb, Rc, and Rd as shown in FIG. 3, a smaller or larger context window may be employed. A smaller context window may include fewer than all of Ra, Rb, Rc, and Rd. A larger context window may include all or some of the neighboring pixels, Ra, Rb, Rc, and Rd, as well as additional neighboring pixels, such as pixels below and or to the right of the current pixel, Ix. The alternate context windows and neighboring pixels may be used to compute alternate local gradients.

B. Quantized Gradient Merging Optimization

The Fast JPEG-LS based compression method 200 may include an optimization related to quantized gradient merging 204. The quantized gradient merging procedure 204 may be based upon the quantized local gradients 202 as computed above. As the probability of a local gradient taking the value Px may be assumed to be the same as the probability of that local gradient taking the value −Px, the Fast JPEG-LS quantizer may be symmetric about zero. Hence, the quantized triplets (Q1, Q2, Q3) may be merged with the context obtained from (−Q1, −Q2, −Q3).

With a conventional JPEG-LS merging process, first, if the first non-zero element of the vector (Q1, Q2, Q3) is negative, then all the signs of the vector (Q1, Q2, Q3) are reversed to obtain (−Q1, −Q2, −Q3). In such a case, the variable “Sign” is set to −1; else the variable “Sign” is set to +1. Then, after this possible “merging,” the vector (Q1, Q2, Q3) is mapped, on a one-to-one basis, into an integer Q representing the context for the sample Rx. Additionally, a standard merging process may involve some additional logical steps per Regular Mode pixel that results in an increase in the computational time.

On the other hand, with the Fast JPEG-LS algorithm, before performing quantization gradient merging, an initial one-to-one mapping of the vector (Q1, Q2, Q3) into an integer Q that represents the current pixel's context may be performed. Any function that results in a continuous quantization Q value for Q1, Q2, and Q3 may be used. In one embodiment, the Fast JPEG-LS algorithm uses a very simple mapping function:

Q=Q₁×R²+Q₂×R+Q₃

where R is the total number of quantization regions, such as 9 in the default example. Alternatively, instead of the above equation, other mapping functions, such as equations or computations that yield a continuous quantization value Q for each quantization vector Qi determined, may be used. For instance, linear, non-linear, polynomial, regressions, transforms, and other equations may be used.

Once these quantization vectors are mapped into a quantization value Q representing the current pixel's context, the merging operations may be performed as follows:

### Q=−Q; Sign=−1, if Q<0;

Sign=+1 otherwise

In other words, the Fast JPEG-LS method may map quantization vectors into single quantization values Q. The Fast JPEG-LS may then check the sign of the quantization value Q, either − or +, to facilitate the completion of the merging process and determine subsequent operations. As a result, a number of logical steps associated with conventional JPEG-LS techniques may be eliminated.

In sum, with the manner identified above, only one logical step may be required per pixel. As only a single computation may be required for each quantization value, the gradient merging process may be simplified. Therefore, the gradient merging optimization of the present embodiments may yield a more efficient compression technique that requires less time and/or processing and memory resources, as compared to other JPEG-LS based techniques.

C. Prediction and Prediction Error Computation Optimizations

The Fast JPEG-LS based compression method 200 may include an optimization related to prediction and/or error prediction 206. In general, JPEG-LS may use an edge detecting predictor method to estimate the prediction value Px at the current pixel Ix from the four neighboring pixels Ra, Rb, Re and Rd. This prediction procedure may be used to detect the vertical and horizontal edges. If no edge is detected, the value at 1x would be equal to the plane passing through Ra, Rb and Rc. Table 4 below illustrates a standard JPEG-LS predictor.

TABLE 4
Standard JPEG-LS Predictor

| | | | |
|---|---|---|---|
| | | min(Ra, Rb) | if Rc ≧ max(Ra, Rb) |
| Px = | {open oversize brace} | max(Ra, Rb) | if Rc ≦ min(Ra, Rb) |
| | | Ra + Rb − Rc | Otherwise |

Using the value of the prediction Px, the prediction error may be calculated as follows:

Err Val=Ix−Px

ErrVal=Err Val, if Sign=−1

The standard prediction method may have the following major limitations. First, the prediction determination is relatively rudimentary in its form and may detect only vertical and horizontal lines, not diagonal lines. Moreover, the above prediction method may not be very useful with smooth images in which the presence of distinct edges may be scarcely found. Second, the above prediction method may not take into account the presence of noise in the image data that might heavily contribute to the prediction value. The wrong prediction due to noise may degrade the compression ratio by falsely indicating the presence of edges, as well as increase the computational burden. Moreover, a conventional JPEG-LS prediction method may involve additional logical steps per pixel that further increase the complexity of the algorithm.

On the other hand, the Fast JPEG-LS algorithm may use a unique prediction method that takes into account the neighbors of the current pixel:

Px=ka.Ra+kb.Rb+kc.Rc+kd.Rd

where ka+kb+kc+kd=1

and ka, kb, kc, kd≧0

As illustrated by the above equation, the Fast JPEG-LS prediction method computes a final prediction value, Px, that may account for the contribution of more than one pixel to the final prediction value. As a result, the influence of noise present in any of the neighboring pixels, such as Ra, Rb, Rc, and Rd, may be decreased. Moreover, the prediction value Px may be computed via a single equation. Hence, the Fast JPEG-LS prediction technique may reduce the number of logical steps per pixel as compared to a conventional JPEG-LS technique. Thus, the Fast JPEG-LS prediction technique may contribute further to the improved efficiency of the overall compression and reconstruction algorithm.

In addition to the exemplary prediction equation identified above, other equations that reduce the number of logical steps per pixel in computing a predicted value Px may be used. For instance, other equations that estimate Px in a single step may be used. The prediction equations may operate on information related to some or all of a current pixel's neighboring pixels simultaneously. Accepting information related to a number of neighboring pixels as inputs to a single equation may enhance computational efficiency.

In one embodiment, the prediction technique may use a weighted average equation. The weighted average equation may account for noise of some or all of the neighboring pixels of the current pixel by averaging out the effect of the noise associated with any noisy neighboring pixels.

D. Results of the Fast JPEG-LS Optimizations

The Fast JPEG-LS algorithm was tested on a series of 8-bit gray medical images. The results shown in Tables 5 and 6 below compare the performance of the compression algorithms both in terms of speed and compression ratio.

TABLE 5
Compression Times in mSecs

| Images | JPEG-LS | Fast JPEG-LS |
|---|---|---|
| CT Patient Data | 38.00 | 21.00 |
| CT Abdomen | 31.00 | 19.00 |
| CT Lung | 43.00 | 19.00 |
| CT Angio | 32.00 | 18.00 |
| CT Liver | 27.00 | 15.00 |
| CT Dental | 28.00 | 18.00 |
| CT Endoscope | 28.00 | 16.00 |
| CT Leg | 26.00 | 14.00 |
| MR Brain | 10.00 | 5.00 |
| MR Whole Body | 11.00 | 6.00 |
| PET Data | 3.00 | 1.00 |
| Average | 25.18 | 13.82 |

Table 5 above shows compression times in milli-seconds for a number of different types of medical images that were compressed. As detailed, the Fast JPEG-LS method employed was substantially faster than JPEG-LS. The Fast JPEG-LS method depicted used the optimizations discussed herein in combination. However, the optimizations may be used individually as well.

TABLE 6
Compression Ratios

| Images | JPEG-LS | FJPLS |
|---|---|---|
| CT Patient Data | 2.21 | 2.20 |
| CT Abdomen | 3.54 | 3.43 |
| CT Lung | 1.89 | 1.90 |
| CT Angio | 1.82 | 1.90 |
| CT Liver | 2.79 | 2.78 |
| CT Dental | 1.71 | 1.70 |
| CT Endoscope | 2.10 | 2.10 |
| CT Leg | 3.04 | 3.04 |
| MR Brain | 1.53 | 1.54 |
| MR Whole Body | 1.92 | 1.89 |
| PET Data | 1.25 | 1.35 |
| Average | 2.16 | 2.17 |

Table 6 above shows compression ratios for the different types of medical images that were compressed. As detailed, the Fast JPEG-LS method employed maintained the compression ratios similar to those of a conventional JPEG-LS technique. In sum, Tables 5 and 6 together illustrate that the Fast JPEG-LS optimizations may improve the compression time by nearly 50 percent without any noticeable degradation of the compression ratio.

### III. Exemplary Data Processor

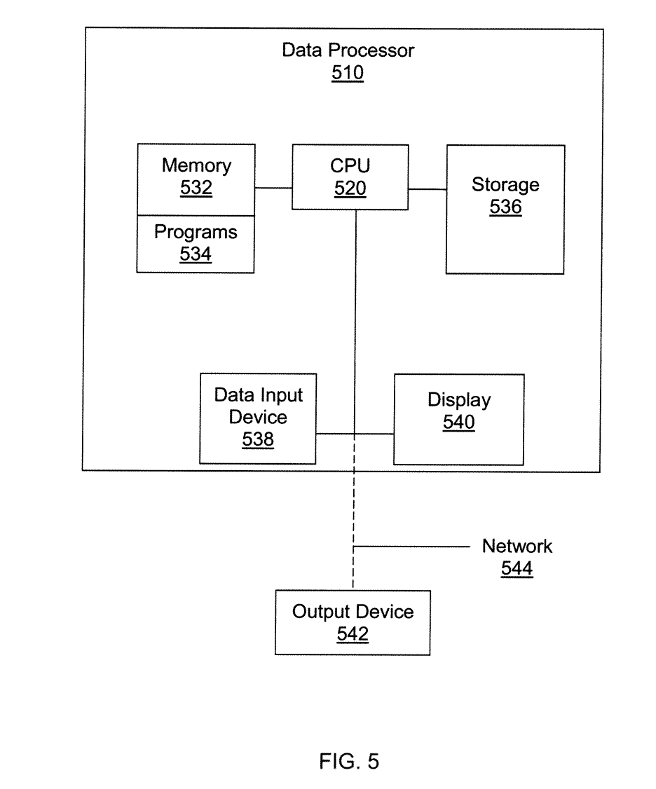

The method for image data compression may be facilitated by a data processing system. FIG. 5 is a block diagram of an exemplary data processor 510 configured or adapted to provide functionality for enhancing the compression and decompression of image data. The data processor 510 may include a central processing unit (CPU) 520, a memory 532, a storage device 536, a data input device 538, and a display 540. The data processor 510 also may have an external output device 542, which may be a display, a monitor, a printer or a communications port. The data processor 510 may be a personal computer, work station server, part of the imaging system, or other system. The data processor 510 may be interconnected to a network 544, such as an intranet, the Internet, or an intranet connected to the Internet. The data processor 510 may be interconnected to another location via the network 544 either by data lines or by wireless communication. The data processor 510 is provided for descriptive purposes and is not intended to limit the scope of the present system. The data processor may have additional, fewer, or alternate components.

A program 534 may reside on the memory 532, storage device 536, or another memory (e.g., hard drive removable media, RAM, or network buffer). The program 534 may include one or more sequences of executable code or coded instructions that are executed by the CPU 520. The program 534 may be loaded into the memory 532 from the storage device 536 or network or removable media.

The CPU 520 may execute one or more sequences of instructions of the program 534 to process data. The program 534 may provide functionality as discussed herein associated with the Fast JPEG-LS optimizations, including the optimizations related to enhancing (1) local gradient quantization, (2) quantized gradient merging, and/or (3) prediction and/or prediction error computations.

Image data may be entered via the data input device 538 or another input device, or received via the network 544 or other network. The data processor 510 may receive and store image data received in the memory 532, the storage device 536, or other storage unit. The program 534 may direct that the data received be stored on or read from machine-readable medium, including secondary storage devices such as hard disks, floppy disks, CD-ROMS, and DVDs; electromagnetic signals; or other forms of machine readable medium, either currently known or later developed.

The program 534 may instruct the data processor 510 to depict images and other information in one or more windows on the display 540, the external output device 542, or other display screen. The image and patient related information may be depicted visually or textually. The data processor 510 may retrieve the image and patient data from machine-readable medium, including secondary storage devices such as hard disks, floppy disks, CD-ROMS, and DVDs; electromagnetic signals; or other forms of machine readable medium, either currently known or later developed.

The program 534 may direct the data processor 510 to scroll through image and patient related information. The data processor 510 may divide the display 540, output device 542, or other display screen into multiple virtual sub-regions. Each of the virtual sub-regions may be associated with a specific image and/or patient. For instance, the display may be split into four quadrants. Other sub-regions may be provided.

The data processor 510. Gay direct the display of image and patient data on the display 540, output device 542, or other display screen. The data processor 510 also may direct the display of icons on the display 540, output device 542, or other display screen. The display 540, output device 542, or other display screen may be a touch screen, a touch pad, a hap tic device, or other vibrational or physical feedback device.

The user interface may accept one or more operations performed on the display. For example, the user interface may provide for the selection of a region of interest within an image, such as after the user moves a cursor via an input device or touches a portion of a touch screen. Other operations may be performed.

While the invention has been described above by reference to various embodiments, it should be understood that many changes and modifications can be made without departing from the scope of the invention. The description and illustrations are by way of example only. Many more embodiments and implementations are possible within the scope of this invention and will be apparent to those of ordinary skill in the art. The various embodiments are not limited to the described environments and have a wide variety of applications.

It is intended in the appended claims to cover all such changes and modifications which fall within the true spirit and scope of the invention. Therefore, the invention is not limited to the specific details, representative embodiments, and illustrated examples in this description. Accordingly, the invention is not to be restricted except in light as necessitated by the accompanying claims and their equivalents.

1. A method of image data compression, the method comprising:
creating a data structure, before commencing compression of image data, associated with quantization values for the image data to be compressed, each quantization value based upon a corresponding local gradient;
subsequently retrieving the quantization values via the data structure to facilitate compression of the image data;
merging quantized gradients by performing a one-to-one mapping of a quantization vector into an integer; and
computing a prediction value using an equation that accepts as input information related to more than one neighboring pixel of the current pixel.

2. The method of claim 1, wherein the prediction value is computed using a weighted average equation to account for noise associated with neighboring pixels.

3. The method of claim 1, the method comprising mapping quantization vectors into an integer value and subsequently checking a sign of the integer value to facilitate a merging process.

4. The method of claim 1, wherein the data structure comprises a look-up table that includes a number of quantization regions defined by thresholds.

5. The method of claim 1, wherein the image data being compressed comprises medical image data.

6. A method of image data compression, the method comprising:
creating a data structure before or at the start of image data compression, the data structure pertaining to quantization values associated with image data to be compressed, each quantization value based upon a corresponding local gradient; and
subsequently retrieving the quantization values via the data structure during compression of the image data.

7. The method of claim 6, the method comprising merging quantized gradients by performing a one-to-one mapping of a quantization vector into an integer.

8. The method of claim 6, the method comprising computing a prediction value using an equation that accepts information related to more than one neighboring pixel of the current pixel as input.

9. The method of claim 8, wherein the prediction value is computed using a weighted average equation to account for noise associated with neighboring pixels.

10. The method of claim 6, wherein the data structure comprises a look-up table that includes a number of quantization regions defined by thresholds.

11. The method of claim 10, the method comprising:
normalizing a local gradient associated with a current pixel; and
looking up a quantization value associated with the current pixel from the look-up table using an index value, the index value being based upon the normalized local gradient.

12. A method of image data compression, the method comprising:
determining pre-computed quantization values associated with image data to be compressed prior to compressing the image data; and
subsequently using the pre-computed quantization values to facilitate compression of the image data.

13. The method of claim 12, the method comprising accessing, during compression of the image data, the pre-computed quantization values via a data structure using indexes, the indexes being based upon local gradients associated with the quantization values.

14. The method of claim 12, the method comprising:
performing a one-to-one mapping of a quantization vector into an integer; and
subsequently checking the value of the integer to facilitate completion of a merging process.

15. The method of claim 12, the method comprising determining a prediction value using an equation that accepts values associated with more than one neighboring pixel of a current pixel as input.

16. The method of claim 12, wherein the image data is medical image data acquired via at least one medical imaging device.

17. A method of image data compression, the method comprising:
during image data compression, performing a one-to-one mapping of a quantization vector into an integer quantization value, and subsequently performing quantization merging.

18. The method of claim 17, wherein logic associated with the quantization merging involves checking the sign of the integer quantization value to determine subsequent steps.

19. The method of claim 17, wherein the quantization merging involves using the sign of the integer quantization value to determine an offset for subsequent use during the image data compression.

20. A data processing system for compressing image data, the system comprising:
a processor operable to compress image data, wherein the processor is operable to employ a prediction method that accounts for noise of neighbor pixels of a current pixel, the prediction method computes a final prediction value using a single equation that operates on information associated with more than one neighbor pixel of the current pixel.

21. The data processing system of claim 20, wherein the processor is operable to merge quantized gradients by performing a one-to-one mapping of a quantization vector into an integer such that the quantization vector is mapped into a continuous quantization value.

22. The data processing system of claim 20, wherein the processor is operable to perform local gradient quantization by creating a data structure prior to image data compression, the data structure being operable to provide access to pre-computed quantization values during the image data compression.

23. The data processing system of claim 20, wherein the image date is medical image data.

24. A computer-readable medium having instructions executable on a computer, the instructions include creating a data structure associated with image data to be compressed, the data structure being operable to provide for subsequent retrieval of pre-computed quantization values during compression of the image data.

25. The computer-readable medium of claim 24, wherein the subsequent retrieval of each of the pre-computed quantization values is based upon an associated local gradient of a corresponding pixel pair.

26. The computer-readable medium of claim 24, wherein the data structure is a look-up table being divided into the quantization regions defined by thresholds.

27. The computer-readable medium of claim 26, the instructions including normalizing each local gradient and adding an offset before retrieving an associated pre-computed quantization value from the data structure.

28. The computer-readable medium of claim 24, the instructions including computing a prediction value for a current pixel based upon a weighted average calculation that accounts for noise associated with neighbor pixels of the current pixel.

29. The computer-readable medium of claim 24, the instructions including performing a one-to-one mapping of a quantization vector into an integer quantization value, and subsequently checking a value of the integer quantization value to facilitate quantization merging.
